(19) United States
(12) Patent Application Publication
(10) Pub. No.: US 2020/0056113 A1
(43) Pub. Date: Feb. 20, 2020

(54) HYDROPHOBIC XEROGEL FILM AND METHOD OF USE THEREOF FOR REDUCING DRAG

(71) Applicant: Mirapakon Inc., Québec (CA)

(72) Inventors: Gary WHIPP, Québec (CA); Olivier MARION, Québec (CA)

(73) Assignee: Mirapakon Inc., Québec, QC (CA)

(21) Appl. No.: 16/301,031

(22) PCT Filed: May 12, 2017
(86) PCT No.: PCT/CA2017/050572

§ 371 Date: Nov. 13, 2018

(51) Int. Cl. C10M 105/76; B63B 1/34; F15D 1/12

(52) U.S. Cl. CPC C10M 105/76; B63B 1/34; C10N 2230/26; C10M 2227/045; F15D 1/12

(57) ABSTRACT

The present disclosure generally relates to drag reducing hydrophobic xerogel films. More particularly, the invention relates to hydrophobic ORMOSIL (organically modified silica) drag reducing film.

### CROSS REFERENCE TO RELATED APPLICATION

This application claims benefit of U.S. provisional application 62/335,742 filed 13-May-2016, the content of which is entirely incorporated herein by reference.

### FIELD OF THE DISCLOSURE

The present disclosure generally relates to drag reducing hydrophobic xerogel films. More particularly, the invention relates to hydrophobic ORMOSIL (organically modified silica) drag reducing film.

### BACKGROUND OF THE DISCLOSURE

The development of technology which produce drag reduction in fluid flows can have profound effect on a number of existing technologies. It is well known that the relative movement of an object through a fluid, like air or water, creates drag forces on the object's surface which slow down its forward movement. It has been shown that some low surface energy hydrophobic coatings can possess friction drag reduction (FDR) properties that can be used in a wide range of applications such as marine vessels and car windows.

A physical body, such as a ship, moving through the water experiences a drag force that opposes forward motion. There are several form of drag forces, the most basic of which are the pressure drag (wave-making) and the friction drag (skin friction). These drag forces contribute to impending forward motion of the object through the fluid medium, thus causing a decrease in speed and/or an increase in power requirements. Decrease drag in a water vessels will enable faster and/or more fuel efficient ships. Such benefit will be particularly useful for commercial and for defense applications.

Various technology have been reported to create drag reducing hydrophobic surfaces. Plastic polymer have been used to coat the surface of marine vessels although the system is not completely satisfactory. Polymers shows a tendency to swell and develop a flabby skin effect that increase drag.

Recent experimental approaches have focused on the so call superhydrophobicity that aim to create hierarchical nanostructure to mimic the leaves of the lotus plant. It was showed that the drag reducing effect of superhydrophobic surfaces was caused by tiny air bubbles trapped in the nanostructures. Some approaches to generate superhydrophobic surfaces include template methods, ion bombardment, lithography, chemical deposition, self-assembly of a monolayer and photo catalysis. The drawbacks of these methods include their high cost, long fabrication times, the fragility of the nanostructure surface and difficulties in covering a large surface area. Moreover, it is challenging to generate a superhydrophoic coating that do not alter the look of the treated surface. Finally, it has been suggested that the drag reducing effect of superhydrophobic surfaces is short lived for immersed structures since the air bubbles trapped in the cavities of the surfaces are diffusing quickly in the surrounding water.

### SUMMARY OF THE DISCLOSURE

The present disclosure provides a combination of silanes, a sol-gel matrix obtained from said silanes as well as surface coating compositions (also referred to as ORMOSIL films) comprising said combination of silanes or sol-gel matrix that can be used to generate a xerogel film.

The present disclosure also provides methods for reducing the drag of an object having an interfacial interaction with a fluid, comprising providing a xerogel film, on at least a portion of a surface of said object.

The present disclosure also provides methods of reducing drag of an object in and/or at the surface of a fluid.

Alkane and fluoroalkane functionality can be incorporated within the xerogel coatings using the sol-gel process. Mixed alkane and perfluoroalkane modifications can be incorporated from appropriate perfluoroalkyl- and alkyltrialkoxysilanes.

In an aspect, the present disclosure provides sol-gel matrix based surface coatings. The xerogel film is prepared from a sol-gel matrix obtained from partial hydrolysis of silanes (e.g., long-chain alkyltrialkoxysilanes, short-chain alkyltrialkoxysilanes, aminoalkyltrialkoxysilanes, alkylaminoalkyltrialkoxysilanes, dialkylaminoalkyltrialkoxysilanes, and perfluororalkyltrialkoxysilanes) composition. The surface coatings are used in a method for reducing drag of an object in a fluid. The coatings are two-, three- or four-component ORMOSIL (organically modified silica) xerogel films (also referred to herein as hybrid films). The xerogel films can be formed by sol-gel methods, such as the methods disclosed herein. In an embodiment, a drag reducing surface coating composition comprises a sol-gel matrix. The sol-gel composition comprises two, three or four silanes.

The present disclosure provides methods for reducing the drag of an object in and/or at the surface of a fluid, comprising providing a xerogel film as defined herein, on at least a portion of a surface of said object.

### DETAILED DESCRIPTION

The present disclosure uses a combination of silanes, a sol-gel matrix obtained from said silanes as well as drag reducing coating compositions comprising said combination of silanes or sol-gel matrix, that can be used to generate a xerogel film.

In one embodiment of the method herein, said reducing of the drag is for an object moving in a fluid and/or at the surface of a fluid.

In one embodiment of the method herein, said reducing of the drag is for an immobile object and said fluid is in contact and is moving relative to said object (e.g. a fluid moving around and/or through and/or at a surface of a fixed object).

The present disclosure provides methods of reducing the drag of an object moving in and/or at the surface of an aqueous environment using the combination of silanes, the sol-gel matrix or composition described herein.

As used herein, a sol-gel matrix is comprising two or more silanes, some of which having been partially hydrolyzed (i.e. some of the alkoxy groups on the silanes having been hydrolyzed to hydroxyl groups), and/or condensed (i.e. at least some of the Si—OH have Si—O—Si bonds), therefore leading to small oligomers comprising siloxane groups derived from the partially hydrolyzed silanes.

Preferably, the sol-gel matrix is obtained from mixing a combination of silanes, and a catalyst for partially hydrolyzing alkoxy groups on the silanes. In one embodiment, the catalyst is an acid, such as an aqueous acid.

As used herein, a composition is comprising a combination of silanes or a sol-gel matrix as defined herein and an organic solvent.

Preferably, the solvent is a water miscible solvent. In one embodiment, the solvent is an alcohol or a mixture of alcohols. Non-limiting examples include methanol, ethanol, isopropanol or mixtures thereof.

In one embodiment, the composition as defined herein is prepared by mixing a combination of silanes, and a catalyst for partially hydrolyzing alkoxy groups on the silanes, wherein said catalyst is an aqueous acid in admixture with a water miscible solvent.

In one embodiment, the molar amount of catalyst for partially hydrolyzing alkoxy groups is from about 0.001 mol % to about 10 mol %.

Alkyl group as used herein, unless otherwise expressly stated, refers to branched or unbranched saturated hydrocarbons.

Examples of alkyl groups include methyl groups, ethyl groups, n-propyl groups, i-propyl groups, n-butyl groups, i-butyl groups, s-butyl groups, pentyl groups, hexyl groups, octyl groups, nonyl groups, and decyl groups and octadecyl groups.

The alkyl group can be unsubstituted or substituted with groups such as halides (—F, —Cl, —Br, and —I), alkenes, alkynes, aliphatic groups, aryl groups, alkoxides, carboxylates, carboxylic acids, and ether groups. For example, the alkyl group can be perfluorinated.

Alkoxy group as used herein, unless otherwise expressly stated, refers to-OR groups, where R is an alkyl group as defined herein. Examples of alkyoxy groups include methoxy groups, ethoxy groups, n-propoxy groups, i-propoxy groups, n-butoxy groups, i-butoxy groups, and s-butoxy groups.

The organically-modified, hybrid xerogel coatings of the present disclosure are used in methods for reducing drag. The xerogel surfaces are inexpensive, have desirable surface roughness/topography, and cover a range of wettabilities (e.g., 85 to)105°, as measured by the static water contact angle, and surface energies (e.g., 21 to 55 mN m⁻¹).

Fluoroalkane functionality can be incorporated within the xerogel coatings using the sol-gel process. Mixed alkane and perfluoroalkane modifications can be incorporated from appropriate perfluoroalkyl- and alkyltrialkoxysilane precursors.

It is possible to generate surface segregation into nm- and/or μm scale structural features on surfaces containing hydrocarbon and fluorocarbon functionality from xerogel coatings prepared from sol-gel precursors incorporating 1 mole % C18 and 1 to 24 mole % tridecafluorooctyltriethoxysilane (TDF) in combination with C8 and 50 mole % TEOS. On the other hand, hybrid three-component xerogels made from combinations of 1,1,1-trifluoropropyltrimethoxysilane (TFP) with phenyltriethoxysilane (PH), n-propyltrimethoxysilane (C3), or n-octyltriethoxysilane (C8) and with tetraethoxysilane (TEOS) as the third component gave uniformly smooth surfaces by time of flight-secondary ion mass spectrometry (ToF-SIMS), scanning electron microscopy (SEM), and atomic force microscopy (AFM).

There was no phase segregation and no distinct topographical features were apparent with short-chain perfluoroalkyltrialkoxysilanes and short-chain (e.g., chains of 3 and 8 carbons) alkyltrialkoxysilanes.

The organically-modified, hybrid xerogel coatings are used in methods for reducing drag. The xerogel materials have tunable surface hydrophobicity and surface energies (by selection of appropriate sol-gel precursors) and are thinner (10-30 μm) with higher elastic modulus than silicone films. When two or more layers of coating are applied, the thickness will proportionally increase (e.g. 20-60μm for 2 layers etc. . . ).

An example of such a xerogel surface is incorporating 1 mole % of an n-octadecyltrimethoxysilane (C18) precursor in combination with n-octyltriethoxysilane (C8) and tetraethoxysilane (TEOS).

Other examples of xerogel surfaces include xerogels prepared from 1:4:45:50 mole % and 1:14:35:50 mole %, respectively, of C18, tridecafluoro-1,1,2,2-tetrahydrooctyl-triethoxysilane (TDF), C8, and TEOS.

Other examples of xerogel surfaces include a xerogel prepared from 50:50 mole % of C8, and TEOS.

Other examples of xerogel surfaces include a xerogel prepared from 1:49:50 mole % of C18, C8, and TEOS.

Other examples of xerogel surfaces include a xerogel prepared from 1:14:35:50 mole % of C18, tridecafluoro-1,1,2,2-tetrahydrooctyl-triethoxysilane (TDF), C8, and TEOS.

Other examples of xerogel surfaces include a xerogel prepared from 20:80 mole % of tridecafluoro-1,1,2,2-tetrahydrooctyl-triethoxysilane (TDF) and TEOS.

The xerogel surfaces are preferably optically transparent.

The xerogel require no “tie” coat, such as an adhesive or an adhesive made of double-sided sticky sheets, for bonding to a variety of surface.

In one embodiment, there is provided methods for reducing the drag of an object in and/or at the surface of a fluid (preferably moving in and/or at the surface of a fluid), comprising providing a xerogel film as defined herein, on at least a portion of a surface of said object.

In one embodiment, the xerogel is obtained by applying the sol-gel matrix or the composition as defined herein in a non-solid form (e.g. liquid or gel form), and as such the method does not require any crushing or other manipulation of a solid to coat the surface of an object for which reduction of drag is desired.

In one embodiment, the method is comprising providing a xerogel on at least a portion of a surface an object in and/or at the surface of a fluid (preferably moving in and/or at the surface of a fluid), wherein said xerogel is obtained by applying the composition as defined herein on said surface, and wherein said composition is comprising two or more silanes, some of which having been partially hydrolyzed and/or condensed, and said composition further comprising a water miscible organic solvent.

For example, the incorporation of low levels (e.g., 1 to 5 mole %) of the long chain n-octadecyltriethoxysilane gave interesting results with respect to surface topography and the separation of phases on the xerogel surfaces. These surfaces were rougher (root-mean-square roughness>1 nm) and had chemically distinct phases as observed by IR microscopy and AFM.

The present disclosure uses a sol-gel matrix or a composition comprising same for coating a surface. The xerogel film is formed from the sol-gel obtained from hydrophobic silanes. The surface coatings are used in methods for reducing drag. The coatings are preferably obtained from two- three- or four-component ORMOSIL (organically modified silica) xerogel films (also referred to herein as hybrid films). The xerogel films can be formed by sol-gel methods, such as disclosed herein.

In an embodiment, a drag reducing surface coating composition comprises a sol-gel matrix. The composition comprises two, three or four partially hydrolyzed and/or condensed silanes. In another embodiment, the drag reducing coating consists essentially of a sol-gel matrix and the composition consists essentially of partially hydrolyzed and/or condensed silanes. In another embodiment, the drag reducing coating consists essentially of a sol-gel matrix and the composition consists essentially of three partially hydrolyzed and/or condensed silanes. In another embodiment, the drag reducing coating consists essentially of a sol-gel matrix and the composition consists essentially of four partially hydrolyzed and/or condensed silanes. In yet another embodiment, the drag reducing coating consists of a sol-gel matrix and the composition consists of two partially hydrolyzed and/or condensed silanes. In yet another embodiment, the drag reducing coating consists of a sol-gel matrix and the composition consists of three partially hydrolyzed and/or condensed silanes. In yet another embodiment, the drag reducing coating consists of a sol-gel matrix and the composition consists of four partially hydrolyzed and/or condensed silanes.

In an embodiment, a drag reducing surface coating composition comprises a sol-gel matrix obtained from two, three or four partially hydrolyzed and/or condensed silanes, and the composition is further comprising a solvent, preferably an alcohol or a mixture of alcohols and even more preferably methanol, ethanol, isopropanol or mixtures thereof.

In an embodiment, a first silane is a long-chain alkyltrialkoxysilane, a perfluoalkyltrialkoxysilane, or is selected from an aminoalkyltrialkyoxysilane, alkylaminoalkyltrialkoxysilane, and dialkylaminoalkyltrialkoxysilane. A second silane is a short-chain alkyltrialkoxysilane, or, if the first precursor component is an aminoalkyltrialkyoxysilane, alkylaminoalkyltrialkoxysilane, or dialkylaminoalkyltrialkoxysilane, then the second precursor is a long-chain alkyltrialkoxysilane. A third silane is a tetraalkoxysilane.

In another embodiment, where the first silane is a long-chain alkyltrialkoxysilane, the sol-gel processed composition further comprises a fourth silane that is a perfluoroalkyltrialkoxysilane.

In an embodiment, the third silane makes up the remainder of the precursor composition.

In the following embodiments, the mole % of the described silanes account for the relative amounts of the silanes. The total mole % of any combination in any given embodiment accounts to 100%.

In an embodiment, the three-component xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with 20 mole % to 55 mole % of a short-chain alkyltrialkoxysilane (such as, but not limited to, n-propyltrimethoxysilane (C3) or n-octyltriethoxysilane (C8)) and a tetraalkoxysilane (such as, but not limited to, tetramethoxysilane (TMOS), tetraethoxysilane (TEOS), or tetraisopropoxysilane (TIPOS).

In embodiment, 1 mole % to 45 mole % of a long-chain perfluoroalkyltrialkoxysilane (where long-chain refers to eight (8) or more carbons such as, but not limited to, tridecafluorooctyltriethoxysilane (TDF) or tridecafluorooctyltrimethoxysilane) in combination with 20 mole % to 55 mole % of a short-chain alkyltrialkoxysilane (such as, but not limited to, n-propyltrimethoxysilane (C3) or n-octyltriethoxysilane (C8)) and a tetraalkoxysilane (such as, but not limited to, tetramethoxysilane (TMOS), tetraethoxysilane (TEOS), or tetraisopropoxysilane (TIPOS)) are incorporated in the surface.

In an embodiment, 1 mole % to 20 mole % of an aminoalkyl-, alkylaminoalkyl-, or dialkylaminoalkyltrialkoxysilane (such as, but not limited to, aminopropyltriethoxysilane (AP), methylaminopropyltriethoxysilane (MAP), or dimethylaminopropyltriethoxysilane (DMAP)) in combination with mole % to 45 mole % of a long-chain perfluoroalkyltrialkoxysilane (where long-chain refers to eight (8) or more carbons such as, but not limited to, tridecafluorooctyltriethoxysilane (TDF) or tridecafluorooctyltrimethoxysilane) and a tetraalkoxysilane (such as, but not limited to, tetramethoxysilane (TMOS), tetraethoxysilane (TEOS), or tetraisopropoxysilane (TIPOS)) are incorporated in the surface.

In an embodiment, 1 mole % to 20 mole % of an aminoalkyl-, alkylaminoalkyl-, or dialkylaminoalkyltrialkoxysilane (such as, but not limited to, aminopropyltriethoxysilane (AP), methylaminopropyltriethoxysilane (MAP), or dimethylaminopropyltriethoxysilane (DMAP)) in combination with 1 mole % to 45 mole % of a longer-chain alkyltrialkoxysilane (where longer-chain refers to eight (8) or more carbons, such as, but not limited to, n-octyltriethoxysilane (C8), n-dodecyltriethoxysilane (C12), or n-octadecyltriethoxysilane (C18)) and a tetraalkoxysilane (such as, but not limited to, tetramethoxysilane (TMOS), tetraethoxysilane (TEOS), or tetraisopropoxysilane (TIPOS)) are incorporated in the surface.

In an embodiment, a first silane is a short-chain alkyltrialkoxysilane, and a second silane is a tetraalkoxysilane. In an embodiment, 50:50 mole % of said alkyltrialkoxysilane, and said tetraalkoxysilane are present.

In an embodiment, a first silane is a long-chain alkyltrialkoxysilane, a second silane is a short-chain alkyltrialkoxysilane, and third silane is a tetraalkoxysilane.

In an embodiment, the three-component xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with 20 mole % to 55 mole % of a short-chain alkyltrialkoxysilane (such as, but not limited to, n-propyltrimethoxysilane (C3) or n-octyltriethoxysilane (C8)) and further in combination with about 50 mole% of a tetraalkoxysilane (such as, but not limited to, tetramethoxysilane (TMOS), tetraethoxysilane (TEOS), or tetraisopropoxysilane (TIPOS)).

In an embodiment, the three-component xerogel surface incorporates about 1 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with about 49 mole % of a short-chain alkyltrialkoxysilane (such as, but not limited to, n-propyltrimethoxysilane (C3) or n-octyltriethoxysilane (C8)) and further in combination with about 50 mole% of a tetraalkoxysilane (such as, but not limited to, tetramethoxysilane (TMOS), tetraethoxysilane (TEOS), or tetraisopropoxysilane (TIPOS)).

In an embodiment, a first silane is a long-chain alkyltrialkoxysilane, a silane component is a perfluoalkyltrialkoxysilane, a third silane is short-chain alkyltrialkoxysilane, and a fourth silane is a tetraalkoxysilane.

In an embodiment, the four-component xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor, in combination with 1 mole % to 45 mole % of a perfluoroalkyltrialkoxysilane (where perfluoroalkyltrialkoxysilane refers to tridecafluorooctadecyltriethoxysilane or tridecafluorooctyltrimethoxysilane, in combination with 20 mole % to 55 mole % of a short-chain alkyltrialkoxysilane (such as, but not limited to, n-propyltrimethoxysilane (C3) or n-octyltriethoxysilane (C8)) and further in combination with about 50 mole % of a tetraalkoxysilane (such as, but not limited to, tetramethoxysilane (TMOS), tetraethoxysilane (TEOS), or tetraisopropoxysilane (TIPOS)).

In an embodiment, the four-component xerogel surface incorporates about 1 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor, in combination with about 14 mole % of a perfluoroalkyltrialkoxysilane (where perfluoroalkyltrialkoxysilane refers to tridecafluorooctadecyltriethoxysilane or tridecafluorooctyltrimethoxysilane in combination with about 35 mole % of a short-chain alkyltrialkoxysilane (such as, but not limited to, n-propyltrimethoxysilane (C3) or n-octyltriethoxysilane (C8)), and further in combination with about 50 mole % of a tetraalkoxysilane (such as, but not limited to, tetramethoxysilane (TMOS), tetraethoxysilane (TEOS), or tetraisopropoxysilane (TIPOS)).

The sol-gel precursors are long-chain alkyltrialkoxysilanes, short-chain alkyltrialkoxysilanes, aminoalkyltrialkoxysilanes, alkylaminoalkyltrialkoxysilanes, dialkylaminoalkyltrialkoxysilanes, and perfluororalkyltrialkoxysilanes. The sol-gel precursors can be obtained from commercial sources or synthesized by known methods.

The long-chain alkyltrialkoxysilane has a long-chain alkyl group and three alkoxy groups. In one embodiment, the long-chain alkyltrialkoxysilane has the following structure:

(RO)₃-Si—R′

where, in this structure, R′ is a long-chain alkyl group and R is an alkyl group of an alkoxy group. The long chain alkyl group is a C₁₀ to C₃₀, including all integer numbers of carbons and ranges there between, alkyl group. The alkoxy groups are, independently, C₁, C₂, or C₃ alkoxy groups. The alkoxy groups can have the same number of carbons. The long-chain alkyltrialkoxysilane is present as a first component at from 0.25 mole % to 5.0 mole %, including all values to the 0.1 mole % and ranges there between, or as a second component at 1 mole % to 45 mole %, including all integer mole % values and ranges there between. Examples of suitable long-chain alkyltrialkoxysilanes include n-dodecyltriethoxysilane, n-octadecyltriethoxysilane, and n-decyltriethoxysilane.

In one embodiment, the short-chain alkyltrialkoxysilane has the following structure:

(RO)₃-Si—R′

where, in this structure, R′ is a short-chain alkyl group and R is an alkyl group of an alkoxy group. The short-chain alkyltrialkoxysilane has a short-chain alkyl group and three alkoxy groups. The short-chain alkyl group is a C₁ to C₈, or preferably C₃ to C₈, alkyl including all integer numbers of carbons and ranges there between, alkyl group The alkoxy groups are, independently, C₁, C₂, or C₃ alkoxy groups. The alkoxy groups can have the same number of carbons. The short-chain alkyltrialkoxysilane is present at 20 mole % to 55 mole %, including all integer mole % values and ranges there between. Examples of suitable short-chain alkyltrialkoxysilanes include n-propyltrimethoxy silane, n-butyltriethoxysilane, n-pentyltriethoxysilane, n-hexyltriethoxysilane, n-heptyltriethoxysilane, n-octyltriethoxysilane, and branched analogues thereof.

In one embodiment, the aminoalkyltrialkoxysilane has an aminoalkyl group and three alkoxy groups. The aminoalkyltrialkoxysilane has the following structure:

(RO)₃-Si—R′—NH₂

where, in this structure, R′ is a an alkyl group of the aminoalkyl group and R is an alkyl group of an alkoxy group. The aminoalkyl group has a C₁ to C₁₀ alkyl, including all integer numbers of carbons and ranges there between, aminoalkyl group. The alkoxy groups are, independently, C₁, C₂ or C₃ alkoxy groups. The alkoxy groups can have the same number of carbons. The aminoalkyltrialkoxy silane is present at 1 mole % to 20 mole %, including all integer mole % values and ranges there between. Examples of suitable aminoalkyltrialkoxysilanes include aminomethyltriethoxysilane, aminoethyltriethoxysilane, aminopropyltriethoxysilane, aminobutyltriethoxysilane, aminopentyltriethoxysilane, and aminohexyltriethoxysilane.

In one embodiment, the alkylaminoalkyltrialkylsilane has an alkylamino group, aminoalkyl group, and three alkoxy groups. The alkylaminoalkyltrialkoxysilane has the following structure:

(RO)₃—Si—R′—NH—R″

where, in this structure, R″ is the alkyl group of the alkylamino group and R′ is a the alkyl group of the alkylaminoalkyl group and R is an alkyl group of a alkoxy group. The aminoalkyl group has a C₁ to C₁₀, including all integer numbers of carbons and ranges there between, alkyl group. The aminoalkyl group has a C₁ to C₁₀, including all integer numbers of carbons and ranges there between, alkyl group. The alkoxy groups are, independently, C₁, C₂, or C₃ alkoxy groups. The alkylaminoalkyltrialkoxysilane is present at 1 mole % to 20 mole %, including all integer mole % values and ranges there between. The alkoxy groups can have the same number of carbons. Examples of suitable alkylaminoalkyltrialkoxysilanes include methylaminoethyltriethoxysilane, methylaminopropyltriethoxysilane, methylaminobutyltriethoxysilane, methylaminopentyltriethoxysilane, methylaminohexyltriethoxysilane, and ethyl and propyl amino analogues thereof.

In one embodiment, the dialkylaminoalkyltrialkoxysilane has the following structure:

(RO)₃—Si—R′—N—(R″) (R′″)

where, in this structure, R′ and R″ are each an alkyl group of the alkylamino group and R′″ is the alkyl group of the dialkylaminoalkyl group and R is an alkyl group of a alkoxy group. The dialkylaminoalkyltrialkylsilane has a dialkylamino group, aminoalkyl group, and three alkoxy groups. The alkyl groups of the diaminoalkyl group are, independently, C₁ to C₁₃, including all integer numbers of carbons and ranges there between, alkyl groups. The dialkylamino alkyl groups can have the same number of carbons. The aminoalkyl group has a C₁ to C₁₀, including all integer numbers of carbons and ranges there between, alkyl group. The alkoxy groups are, independently, C₁, C₂, or C₃ alkoxy groups. The alkoxy groups can have the same number of carbons. The dialkylaminoalkyltrialkoxysilane is present at 1 mole % to 20 mole %, including all integer mole % values and ranges there between. Examples of suitable dialkylaminoalkyltrialkoxysilanes include dimethylaminoethyltriethoxysilane, dimethylaminopropyltriethoxysilane, dimethylaminobutyltriethoxysilane, dimethylaminopentyltriethoxysilane, dimethylaminohexyltriethoxysilane, and diethylamino and dipropylamino analogues thereof.

In one embodiment, the perfluoroalkyltrialkoxysilane has the following structure:

(RO)₃—Si—R′

where, in this structure, R′ is a perfluoroalkyl group and R is an alkyl group of an alkoxy group. The perfluoroalkyltrialkoxysilane has a perfluoroalkyl group and three alkoxy groups. The pefluoroalkyl group is a C₈ to C₃₀, including all integer numbers of carbons and ranges there between, alkyl group. The alkoxy groups are, independently, C₁, C₂, or C₃ alkoxy groups. The alkoxy groups can have the same number of carbons. The perfluoroalkyltrialkoxysilane is present at 1 mole % to 45 mole %, including all integer mole values and ranges therebetween. Examples of suitable perfluoroalkyltrialkoxysilanes include tridecafluorooctadecyltriethoxysilane and tridecafluorooctyltrimethoxysilane.

In one embodiment, the tetraalkoxysilane has the following structure:

(RO)₃—Si—OR

where, in this structure, R is an alkyl group of an alkoxy group. The alkoxy groups are, independently, C₁, C₂, or C₃ alkoxy groups. The alkoxy groups can have the same number of carbons.

The sol-gel matrix or coating compositions comprise functional groups derived from the precursor silanes. For example, coatings formed using perfluoroalkyltrialkoxysilanes have perfluoroalkyl groups. The surface coatings also have residual silanol functional groups. The groups can be on the surface of the film or in the bulk matrix of the film.

The thickness of the xerogel can be varied based on the deposition method and/or parameters of the deposition process (e.g., concentrations of the precursor components). For example, the film can have a thickness of 1 micron to 35 microns, including all integer thickness values and ranges there between.

The sol-gel matrix surface coatings have desirable properties. For example, the coatings have desirable wetting properties (which can be measured by, for example, contact angle) and surface roughness. In various examples, the contact angle of the film is greater than 95 degrees or greater than 100 degrees. For example, the contact angle of the coating is between 85 and 150 degrees, including all integer degree values and ranges thereof. For example, the surface roughness is greater than 1 nm. For example, the surface roughness is between 1 and 20 nm, including all values to the nm and ranges thereof.

The surface roughness can lead to topographical features, such as nanopores, as is observed with the 1:49:50 C18/C8/TEOS xerogel, while smooth or rough surfaces can have phase segregation of hydrocarbon, fluorocarbon and silicon oxide features as observed for 1:49:50 C18/C8/TEOS, 1:4:45:50 C18/TDF/C8/TEOS and 1:14:35:50 C18/TDF/C8/TEOS xerogels.

In an embodiment, drag reducing surface coating composition comprises a sol-gel matrix made by a method comprising the following steps: forming a precursor composition comprising two, three or four sol-gel precursor components, coating the precursor composition on a surface such that a sol-gel matrix film is formed on the surface.

Generally, the precursor composition (referred to herein as a sol) is formed by combining two, three or four sol-gel precursor components and allowing the components to stand for a period of time such that a desired amount of hydrolysis and polymerization of the precursors occurs. This precursor composition is coated on a surface and allowed to stand for a period of time such that a xerogel film is formed. The determination of specific reaction conditions (e.g., mixing times, standing times, acid/base concentration, solvent(s)) for forming the xerogel film is within the purview of one having skill in the art.

In another aspect, the present disclosure provides methods for reducing the drag of object in and/or at the surface of fluid (preferably moving in and/or at the surface of a fluid), such as an aqueous environment.

As used herein, fluid may preferably refer to an aqueous environment. Examples of such aqueous environments include freshwater and saltwater environments. The aqueous environments can be naturally occurring or man-made. Examples of aqueous environments include rivers, lakes, and oceans. Additional examples of aqueous environments include tanks of freshwater or saltwater.

The surface is any surface that can be contacted with an aqueous environment. The surfaces can be materials such as metals (such as marine grade aluminum), plastics, composites (such as fiberglass), glass, wood, or other natural fibers. Examples of suitable surfaces include surfaces of a water-borne vessel such as a boat, ship and personal watercraft.

The drag reduction effect can alternatively be expressed as the effect of accelerating the flow of a fluid relative to the object, such as in pipe or conduits. The effect can have various applications, such as in pipelines operations, oil well operations, (flood/waste or domestic) or water circulation, firefighting operations, irrigation, transport of suspensions and slurries (preferably aqueous), sewer systems, water heating and cooling systems, airplane tank filling, marine systems and equipment (including vessels), and biomedical systems including blood flow.

In an embodiment, the method comprises the step of applying a coating of drag reducing coating composition as described herein to at least a portion of a surface subjected to an aqueous environment such that such an ORMOSIL xerogel film is formed on the surface.

The coating of drag reducing coating composition can be applied by a variety of coating methods. Examples of suitable coating methods including spray coating, dip coating, brush coating, or spread coating.

The sol-gel matrix coating can be formed by acid-catalyzed hydrolysis and polymerization of the precursor components. In an embodiment, the drag reducing precursor composition further comprises an acidic component that makes the pH of the composition sufficiently acidic so that the components undergo acid-catalyzed hydrolysis to form the sol-gel matrix. Examples of suitable acidic components include aqueous acids such as hydrochloric acid, hydrobromic acid and trifluoroacetic acid. Conditions and components required for acid-based hydrolysis of sol-gel components are known in the art.

After applying the coating of drag reducing coating composition, the coating is allowed to stand for a time sufficient to form the xerogel. Depending on the thickness of the coating, the standing time is, for example, from 1 hour to 72 hours including all integer numbers of hours and ranges there between and up to 1 or more days.

The steps of the methods described in the various embodiments and examples disclosed herein are sufficient to practice the methods of the present disclosure. Thus, in an embodiment, the method consists essentially of a combination of the steps of a method disclosed herein. In another embodiment, the method consists of such steps.

The following examples are presented to illustrate the present disclosure. They are not intended to be limiting in any manner.

Materials and Methods. Chemical Reagents. Deionized water was prepared to a specific resistivity of at least 18 MΩ using a Barnstead NANOpure Diamond UV ultrapure water system. Tetraethoxysilane or tetraethyl orthosilicate (TEOS), n-propyltrimethoxysilane (C3), n-octadecyltrimethoxysilane (C18), n-octyltriethoxy-silane (C8), 3,3,3-trifluoropropyltrimethoxysilane (TFP), tridecafluorooctyltriethoxysilane (TDF), 3-aminopropyltriethoxysilane (AP), methylaminopropyltriethoxysilane (MAP), and dimethylaminopropyltriethoxysilane were purchased from Gelest, Inc. and were used as received. Ethanol was purchased from Quantum Chemical Corp. Hydrochloric acid was obtained from Fisher Scientific Co. Borosilicate glass microscope slides were obtained from Fisher Scientific, Inc.

Sol Preparation. The sol/xerogel composition is designated in terms of the molar ratio of Si-containing precursors. Thus, a 50:50 C8/TEOS composition contains 50 mole % C8 and 50 mole % TEOS.

Sol TEOS. TEOS (3.96 g, 17.1 mmol, 3.35 mL), water (0.54 mL), ethanol (3.40 mL), and HCL (0.1 M, 15 μL) were stoppered in a glass vial and stirred at ambient temperature for 6 hours.

Sol AP. AP (2.544 g, mmol) was added dropwise to a stirred mixture of 6.67 M HCl (2.000 mL) and ethanol (10.56 ml). Once addition was complete the solution was mixed via sonication at ambient temperature for 40 min.

10:90 AP/TEOS. A mixture of sol TEOS (3.353 mL) and sol AP (1.000 mL) was sonicated for 20 min at ambient temperature.

10:90 TMAP/TEOS. A mixture of TEOS (2.4 g, 64.1 mmol), TMAP (0.50 g, 1.2 mmol), water (1.8 mL), ethanol (3.0 mL), and 12 M HCl (5.2 .mu.L) was stirred at ambient temperature for 12 hours.

Sol DMAP. DMAP (1.054 g, 4.827 mmol) was added dropwise to a mixture of 6.67 M HCl (0.955 mL) and ethanol (4.668 mL). The resulting solution was stirred at ambient temperature for 40 min.

10:90 DMAP/TEOS. Sol DMAP (5.11 ml, 3.68 mmol) was added dropwise to sol TEOS (16.2 ml, 33.1 mmol). The mixture was stirred at ambient temperature for 20 min.

Sol MAP. MAP (2.000 g, 10.34 mmol) was added dropwise to 6.67 M HCl (2.04 mL, 15 mmol) and ethanol (10.0 mL). The resulting solution was stirred at ambient temperature for 40 min.

10:90 MAP/TEOS. Sol MAP (5.013 ml, 3.68 mmol) was added dropwise to sol TEOS (16.2 mL, 33.1 mmol). The resulting mixture was stirred at ambient temperature for 20 min.

50:50 TFP/TEOS. A mixture of TEOS (1.82 g, 7.8 mmol), TFP (1.70 g, 7.8 mmol), H₂O(0.563 ml, 31 mmol), and ethanol (3.5 ml, 60 mmol) was capped and sonicated at ambient temperature for 0.5 hour.

50:50 C3/TEOS. A mixture of C3 (2.0 g, 12.17 mmol), TEOS (2.53 g, 12.17 mmol), ethanol (4.0 mL), and 0.1 N HCl (2.1 mL, 0.21 mmol) was capped and stirred at ambient temperature for 8 hours.

25:25:50 TFP/C8/TEOS. A mixture of C8 (1.25 g, 4.5 mmol), TFP (1.0 g, 4.5 mmol), TEOS (1.8 g, 9.0 mmol), ethanol (3.0 mL), and 0.1 N HCl (1.6 mL, 0.16 mmol) was stirred at ambient temperature for 3 hours.

25:25:50 TFP/C3/TEOS. A mixture of C3 (0.93 g, 4.5 mmol), TFP (1.0 g, 4.5 mmol), TEOS (1.87 g, 9.0 mmol), ethanol (3.0 mL), and 0.1 N HCl (1.6 mL, 0.16 mmol) was stirred at ambient temperature for 3 hours.

50:50 C8/TEOS. A mixture of TEOS (2.70 g, 13 mmol), C8 (3.59 g, 13 mmol), ethanol (5.0 mL, 87 mmol) and 0.1 N HCl (1.6 mL, 0.16 mmol) was capped and stirred at ambient temperature for 24 hours. 5:45:50 C18/C8/TEOS. A mixture of C18 (0.269 g, 0.72 mmol, 0.305 mL), C8 (1.79 g, 6.48 mmol, 2.03 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

4:46:50 C18/C8/TEOS. A mixture of C18 (0.215 g, 0.58 mmol, 0.244 mL), C8 (1.83 g, 6.62 mmol, 2.08 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

3:47:50 C18/C8/TEOS. A mixture of C18 (0.161 g, 0.43 mmol, 0.183 mL), C8 (1.87 g, 6.77 mmol, 2.12 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

2:48:50 C18/C8/TEOS. A mixture of C18 (0.108 g, 0.29 mmol, 0.122 mL), C8 (1.91 g, 6.91 mmol, 2.17 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

1:49:50 C18/C8/TEOS. A mixture of C18 (0.054 g, 0.14 mmol, 0.061 mL), C8 (1.95 g, 7.06 mmol, 2.21 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

10:90 TDF/TEOS. TDF (0.288 g, 0.533 mmol, 0.213 mL), and TEOS (1.0 g, 4.80 mmol, 1.07 mL) were mixed. Ethanol (1.77 mL), and HCl (0.288 mL, 0.1 M), were added and the resulting solution was stirred at ambient temperature for 24 hours. At this time a 0.400 mL aliquot was removed and spun cast onto a glass microscope slide.

20:80 TDF/TEOS. TDF (0.612 g, 1.2 mmol, 0.453 mL), and TEOS (1.07 g, 4.08 mmol) were mixed. Ethanol (2.0 mL), and HCl (0.583 mL, 0.1 M), were added and the resulting solution was stirred at ambient temperature for 24 hours. At this time a 0.400 mL aliquot was removed and spun cast onto a glass microscope slide.

10:40:50 TDF/C8/TEOS. C8 (1.06 g, 3.84 mmol, 1.21 mL), TDF (0.49 g, 0.96 mmol, 0.363 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

20:30:50 TDF/C8/TEOS. C8 (0.79 g, 2.88 mmol, 0.90 mL), TDF (0.98 g, 1.92 mmol, 0.725 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

30:20:50 TDF/C8/TEOS. C8 (0.53 g, 1.92 mmol, 0.60 mL), TDF (1.47 g, 2.88 mmol, 1.08 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide. 40:20:50 TDF/C8/TEOS. C8 (0.26 g, 0.26 mmol, 0.26 mL), TDF (1.96 g, 3.84 mmol, 1.45 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

5:5:90 DMAP/TDF/TEOS. Sol DMAP (2.489 ml, 1.792 mmol) was added dropwise to a stirring solution of TDF (0.915 g, 1.792 mmol), TEOS (6.72 g, 32.26 mmol), ethanol (5.039 ml), and 0.1M HCl (2.517 ml). The resulting mixture was stirred at ambient temperature for 24 hours.

2:48:50 C12/C8/TEOS. C12 (0.214 g, 0.72 mmol), C8 (5.04 g, 17.3 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

4:46:50 C12/C8/TEOS. C12 (0.418 g, 1.44 mmol), C8 (4.579 g, 16.56 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

5:45:50 C12/C8/TEOS. C12 (0.523 g, 1.80 mmol), C8 (4.35 g, 12.4 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

10:40:50 C12/C8/TEOS. C12 (1.046 g, 3.60 mmol), C8 (3.981 g, 14.40 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

20:30:50 C12/C8/TEOS. C12 (2.092 g, 7.20 mmol), C8 (2.986 g, 10.80 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

1:49:50 C18/TDF/TEOS. C18 (0.135 g, 0.36 mmol), TDF (9.003 g, 17.64 mmol), TEOS (3.750 g, 18.0 mmol), and ethanol (10.90 mL) were mixed together followed by the addition of 0.1 M HCl (2.268 mL). The resulting solution was stirred at ambient temperature for 24 hours.

1:1:48:50 C18/TDF/C8/TEOS. C18 (0.135 g, 0.36 mmol), TDF (0.184 g, 0.36 mmol), C8 (3.750 g, 18.0 mmol), TEOS (3.750 g, 18.0 mmol), and ethanol (8.47 mL) were mixed together followed by the addition of 0.1 M HCl (2.268 mL). The resulting solution was stirred at ambient temperature for 24 hours.

1:4:45:50 C18/TDF/C8/TEOS. C18 (0.135 g, 0.36 mmol), TDF (0.735 g, 1.44 mmol), C8 (4.479 g, 16.2 mmol), TEOS (3.750 g, 18.0 mmol), and ethanol (11.9 mL) were mixed together followed by the addition of 0.1 M HCl (2.268 mL). The resulting solution was stirred at ambient temperature for 24 hours.

1:9:40:50 C18/TDF/C8/TEOS. C18 (0.135 g, 0.36 mmol), TDF (1.654 g, 3.24 mmol), C8 (3.981 g, 14.4 mmol), TEOS (3.750 g, 18.0 mmol), and ethanol (11.9 mL) were mixed together followed by the addition of 0.1 M HCl (2.268 mL). The resulting solution was stirred at ambient temperature for 24 hours. 1:14:35:50 C18/TDF/C8/TEOS. C18 (0.135 g, 0.36 mmol), TDF (2.572 g, 5.04 mmol), C8 (3.484 g, 12.6 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

1:19:30:50 C18/TDF/C8/TEOS. C18 (0.135 g, 0.36 mmol), TDF (3.491 g, 6.84 mmol), C8 (2.986 g, 10.8 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

1:24:25:50 C18/TDF/C8/TEOS. C18 (0.135 g, 0.36 mmol), TDF (4.410 g, 8.64 mmol), C8 (2.488 g, 9.0 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

0.5:1:48.5:50 DMAP/C18/C8/TEOS. C18 (0.135 g, 0.36 mmol), C8 (4.828 g, 17.46 mmol), TEOS (3.750 g, 18.0 mmol), and ethanol (11.835 mL) were mixed together followed by the addition of 0.1 M HCl (2.268 mL). Sol DMAP (0.249 mL, 0.18 mmol) was then added and the resulting solution was stirred at ambient temperature for 24 hours.

Preparation of 1:1:48:50 DMAP/C18/C8/TEOS. C18 (0.135 g, 0.36 mmol), C8 (4.778 g, 17.28 mmol), TEOS (3.750 g, 18.0 mmol), and ethanol (11.64 mL) were mixed together followed by the addition of 0.1 M HCl (2.268 mL). Sol DMAP (0.499 mL, 0.36 mmol) was then added and the resulting solution was stirred at ambient temperature for 24 hours. 1.5:1:47.5:50 DMAP/C18/C8/TEOS. C18 (0.135 g, 0.36 mmol), C8 (4.728 g, 17.10 mmol), TEOS (3.750 g, 18.0 mmol), and ethanol (11.45 mL) were mixed together followed by the addition of 0.1 M HCl (2.268 mL). Sol DMAP (0.748 mL, 0.54 mmol) was then added and the resulting solution was stirred at ambient temperature for 24 hours.

2:1:47:50 DMAP/C18/C8/TEOS. C18 (0.135 g, 0.36 mmol), C8 (4.678 g, 16.92 mmol), TEOS (3.750 g, 18.0 mmol), and ethanol (11.26 mL) were mixed together followed by the addition of 0.1 M HCl (2.268 mL). Sol DMAP (0.997 mL, 0.723 M) was then added and the resulting solution was stirred at ambient temperature for 24 hours.

### EXAMPLE 1

Xerogel Film Formation. Xerogel films were formed by spin casting 400 μL of the sol precursor onto 25-mm×75-mm glass microscope slides. The slides were soaked in piranha solution for 24 hours, rinsed with copious quantities of deionized water then soaked in isopropanol for 10 minutes, were air dried and stored at ambient temperature. A model P6700 spincoater was used at 100 rpm for 10 seconds to deliver the sol and at 3000 rpm for 30 seconds to coat. All coated surfaces were dried at ambient temperature for at least 7 days prior to analysis.

Comprehensive Contact Angle Analysis.

The xerogel films were stored in air prior to characterization. Comprehensive contact angle analyses were performed in air. The approximate sampling depth of the contact angle technique is 5 Å. Up to thirteen different diagnostic liquids were utilized for the analysis of each sample: water, glycerol, formamide, thiodiglycol, methylene iodide, 1-bromonaphthalene, 1-methylnaphthalene, dicyclohexyl, n-hexadecane, n-tridecane, n-decane, n-octane, and n-heptane. Liquid/vapor surface tensions of these liquids were determined directly; reference values for the liquid/vapor surface tensions are not used. The technique of “advanced angle” analysis was used, wherein a sessile drop of liquid (8-15 □L depending on the viscosity of the liquid) is placed on the sample surface and the angle of contact between the liquid and the solid is measured with a contact angle goniometer (Raine-Hart, Model NRL 100); both sides of the droplet profile are measured.

Static water contact angles were measured by the sessile drop technique where the angle between a 15 □L drop of water and the xerogel surface was measured with a contact angle goniometer (Rame-Hart, Model NRL 100); both sides of the droplet profile were measured.

Drag Reduction Measurement.

The drag reduction effect of the various coating was measured using a modified gravitation falling ball viscometer apparatus. This test was done in a 1.6 cm wide column filled with deionised water and the length of the falling path was 38 cm. The drag reduction test was done using Crosman 0.12 g premium balls (6.0 mm diameter; model ASP512). For each coating, 20 balls were used to ensure homogeneity and reduce statistical variations. All tested balls were 0.1115 g±0.0005 g. All balls were washed with isopropanol and coated by dip coating before being left to dry for at least 24 h. Prior to the test in the falling ball viscometer, all coated balls were soaked in deionised water for 1 h and sonicated for 5 minutes to ensure no air bubbles were imprisoned on the coating. The speed of the balls were recorded in the viscometer as they fall from point A to point B. The drag reduction is expressed as a ratio of the mean falling time for the 20 coated balls compared to the mean of 20 blank balls (coated with a glasslike 100% inorganic silica xerogel product).

In this example, two- and three-component, hybrid xerogel surfaces that have high contact angles)(>95° are described. Entry 1 and 2 are comparative examples.

TABLE 1
Water contact angle, surface roughness and speed increase capacity of hybrid
xerogel surface

| | Sample | | Surface | |
|---|---|---|---|---|
| | (mole % of each | Water | roughness^{b} | Speed |
| Entry | component) | contact angle^{a} ° | nm | increase^{c} % |
| 1 | Glass | 21 ± 1 | — | 0 |
| 2 | PDMSE | 109 | — | — |
| 3 | 50:50 C8/TEOS | 104 ± 2 | — | 2.7 |
| 4 | 50:50 C3/TEOS | 99 ± 2 | — | 2.71 |
| 5 | 50:50 TFP/TEOS | 85 ± 1 | — | 5.56 |
| 6 | 10:90 TDF/TEOS | 112 ± 1 | — | 1.96 |
| 7 | 20:80 TDF/TEOS | 109 ± 2 | — | 6.16 |
| 8 | 10:90 DMAP/TEOS | 35 ± 1 | — | — |
| 9 | 5:45:50 C18/C8/TEOS | 108.2 ± 0.9 | — | 5.28 |
| 10 | 4:46:50 C18/C8/TEOS | 105 ± 2 | 0.20 ± 0.01 | 5.24 |
| 11 | 3:47:50 C18/C8/TEOS | 102 ± 4 | 0.22 ± 0.02 | 0.96 |
| 12 | 2:48:50 C18/C8/TEOS | 108.3 ± 0.9 | 0.67 ± 0.03 | 1.81 |
| 13 | 1:49:50 C18/C8/TEOS | 111.2 ± 0.2 | 1.15 ± 0.04 | — |
| 14 | 10:40:50 TDF/C8/TEOS | 104 ± 3 | — | 1.79 |
| 15 | 20:30:50 TDF/C8/TEOS | 104 ± 3 | — | — |
| 16 | 30:20:50 TDF/C8/TEOS | 102 ± 2 | — | 0.72 |
| 17 | 40:10:50 TDF/C8/TEOS | 103 ± 4 | — | — |
| 18 | 1:49:50 DMAP/TDF/TEOS | 108 ± 1 | — | 12.87 |
| 19 | 2:48:50 DMAP/TDF/TEOS | 104 ± 2 | — | — |
| 20 | 3:47:50 DMAP/TDF/TEOS | 105 ± 1 | — | — |
| 21 | 4:46:50 DMAP/TDF/TEOS | 112 ± 2 | — | — |
| 22 | 5:45:50 DMAP/TDF/TEOS | 113.5 ± 0.8 | — | — |
| 23 | 10:40:50 DMAP/TDF/TEOS | 113 ± 1 | — | — |
| 24 | 0.5:49.5:50 | 102 ± 1 | — | — |
| | DMAP/C8/TEOS | | | |
| 25 | 1.0:49.0:50 | 97.6 ± 0.2 | — | 3.64 |
| | DMAP/C8/TEOS | | | |
| 26 | 1.5:48.5:50 | 96.7 ± 0.3 | — | — |
| | DMAP/C8/TEOS | | | |
| 27 | 2.0:48.0:50 | 95.8 ± 0.2 | — | — |
| | DMAP/C8/TEOS | | | |
| 28 | 1:49:50 C18/TDF/TEOS | 97 ± 1 | — | — |
| 29 | 2:48:50 C12/C8/TEOS | 108 ± 1 | — | 3.42 |
| 30 | 4:46:50 C12/C8/TEOS | 104 ± 2 | — | — |
| 31 | 5:45:50 C12/C8/TEOS | 105 ± 1 | — | 1.88 |
| 32 | 10:40:50 C12/C8/TEOS | 112 ± 1 | — | — |
| 33 | 20:30:50 C12/C8/TEOS | 113 ± 1 | — | — |

^{a}Mean of five (5) independent measurements for coatings store in air prior to measurement. ± one standard deviation.
^{b}Average of five (5) replicate measurement. ± one standard deviation.
deviation.
^{c}Average of twenty (20) replicates compared to glass coating.

### EXAMPLE 2

In this example, four-component, hybrid xerogel surfaces that have high contact angles)(>95° and that perform as drag reducing surfaces are described. Entry 1 and 2 are comparative examples.

TABLE 2
Water contact angle, surface roughness and speed increase capacity of
hybrid xerogel surface

| | | Water | |
|---|---|---|---|
| | Sample | contact | Speed |
| Entry | (mole % of each component) | angle^{a} ° | increase^{b} % |
| 1 | Glass | 21 ± 1 | 0 |
| 2 | PDMSE | 109 | — |
| 3 | 1:1:48:50 C18/TDF/C8/TEOS | 113.2 ± 0.9 | — |
| 4 | 1:4:45:50 C18/TDF/C8/TEOS | 106.0 ± 0.2 | 1.81 |
| 5 | 1:9:40:50 C18/TDF/C8/TEOS | 106 ± 1 | 1.94 |
| 6 | 1:14:35:50 C18/TDF/C8/TEOS | 106.1 ± 0.6 | 2.7 |
| 7 | 1:19:33:50 C18/TDF/C8/TEOS | 105 ± 1 | — |
| 8 | 1:24:25:50 C18/TDF/C8/TEOS | 96.5 ± 0.3 | — |
| 9 | 0.5:1:48.5:50 DMAP/C18/C8/TEOS | 102 ± 1 | — |
| 10 | 1.0:1:48.0:50 DMAP/C18/C8/TEOS | 99 ± 1 | 4.59 |
| 11 | 1.5:1:47.5:50 DMAP/C18/C8/TEOS | 96.7 ± 0.3 | — |
| 12 | 2.0:1:47.0:50 DMAP/C18/C8/TEOS | 95.3 ± 0.2 | — |

^{a}Mean of five (5) independent measurements for coatings store in air prior to measurement. ± one standard deviation.
^{b}Average of twenty (20) replicates compared to glass coating.

A number of the two-component and all of the three- and four-component, hybrid xerogel surfaces of Tables 1 and 2 have values of the static water contact angle that are greater than 95 degree. The contact angle appears to be an indicator for the reduction of drag although such a complex process is influenced by many other factors like surface roughness and the chemical nature of the hydrophobic layer.

Results Xerogel Surfaces.

A series of xerogel surfaces containing C12, C18, TFP, TDF, C8, DMAP and TEOS were prepared. The xerogel films prepared by spin coating were 1 to 2 μm thick as measured by profilometry. All of the xerogel films prepared were optically transparent. The balls for the falling balls viscometer were dip coated.

The xerogel surfaces were aged in air at ambient temperature for 7 days and were then examined by comprehensive advanced contact angle analyses to give values of the critical surface tension and the surface free energy. Static water contact angles, were measured for all xerogel surfaces described.

Scanning electron microscopy (SEM) studies of several xerogel surfaces indicate that these surfaces are uniform, uncracked, and topographically smooth when dry. Atomic force microscopy (AFM) measurements on the same series of xerogels submerged in ASW show very low surface roughness and no phase segregation. Time-of-flight, secondary-ion mass spectrometry (ToF-SIMS) studies show that there is no phase segregation of fluorocarbon and hydrocarbon groups on the mm scale in a 25:25:50 trifluoropropyl-trimethoxysilane/C8/TEOS xerogel.

The nature of the cross-linking and functional group distribution in the xerogels differs from that of fluorinated block copolymers that undergo surface reorganization upon exposure to water. Immersion in water did not change the relative intensity of the silanol bands in the surface regions (data not shown) suggesting that further cross-linking of the surface is not responsible for the change.

Xerogel surfaces can be fine-tuned to provide surfaces with different wettability. The topography of the xerogel surfaces can also be fine-tuned by the incorporation of a long-chain alkyl component and varying amounts of the polyfluorinated TDF. The formulation and coating of these TDF-containing xerogel surfaces require no special attention or preparation (pre-patterning). Depositing the xerogel by spin coating leads to self-segregation of hydrocarbon and fluorocarbon domains.

Overall, xerogel surfaces have high potential as drag reducing surfaces as indicated by the results of the falling balls tests. Although the speed increases can seem low to non-skilled personnel, it is known in the art that even a low % of speed increase can translate in huge saving in time, fuel economy, and carbon emissions during the lifetime service of a working ship. Generally, the hydrophobicity of the surfaces enable a speed increase of 1% to 3%. Interestingly, it was found that the roughness of the surface has an important effect on the drag (table 1 entry 10 to 12). In general, a high concentration of fluoro chains enable a greater speed increase even if the water contact angle is lower (see table 1 entry 5 for example). The xerogel surface can be fine tune to generate a hydrophobic smooth material that maximise the drag reduction effect.

### EXAMPLE 3

The 50:50 C8/TEOS xerogel film was tested in real boating conditions on a 27 feet CS27 sailboat propelled by a Yanmar 14 hp diesel motor. One coat of xerogel film was applied by foam roller on the freshly stripped fiberglass hull with a drying time of 48 h. The tests were realised in May of 2016 in the enclose part of the old port of Quebec City (Bassin Louise). In the weeks prior to the coating, the maximum speed attainable using only the propeller (2700 rpm) was 6.5 knots.

Under similar boating condition, (speed measured by ultrasonic Loch under similar boating condition; sunny morning with low to no wind; old port of Quebec City) the coated sailboat was able to achieve a speed of 6.7 knots, a 3.1% increase in speed.

### EXAMPLE 4

### Substrates and Surface Preparation

Surfaces are clean and as dry as conditions permit. For clean surfaces, the surface can be wiped with a cloth and isopropanol prior to coating. Preferably, remove any previous special use coatings before application. Employ adequate methods to remove dirt, dust, oil, wax, grease and all other contaminants that could interfere with adhesion of the coating.

Application Equipment

Two coats of composition may be used. Allow coating to tack over between coats. Tack time will vary (about 1 hour). Sanding of the coating to remove surface imperfections may be accomplished after 24 hours by using a 220 or 350 grit sanding block.

Brush: Use a foam brush.

Roller: Use a smooth or super smooth foam type roller and roller pan. Coat small areas approximately 3 square ft. avoiding extensive re-rolling.

Spray gun: Use a spray gun equipped with a 1.1 mm needle under only 10 psi pressure. Apply back and forth vertically then horizontally.

While the disclosure has been particularly shown and described with reference to specific embodiments (some of which are preferred embodiments), it should be understood by those having skill in the art that various changes in form and detail may be made therein without departing from the present disclosure as disclosed herein.

1. A method for reducing the drag of an object having an interfacial interaction with a fluid, comprising providing a xerogel film, on at least a portion of a surface of said object.

2. The method of claim 1, wherein said step of providing a xerogel film is comprising coating a composition comprising a sol-gel matrix on said at least a portion of a surface of said object.

3. The method of claim 2, wherein said sol-gel matrix is comprising partially hydrolyzed and/or condensed silanes.

4. The method of claim 3, wherein said silanes are alkoxysilanes.

5. The method of claim 4, wherein said alkoxysilanes are comprising long-chain alkyltrialkoxysilanes, short-chain alkyltrialkoxysilanes, aminoalkyltrialkoxysilanes, alkylaminoalkyltrialkoxysilanes, dialkylaminoalkyltrialkoxysilanes, perfluororalkyltrialkoxysilanes or a combination thereof; and a tetraalkoxysilane.

6. The method of claim 2, wherein said sol-gel matrix comprises two, three or four partially hydrolyzed and/or condensed alkoxysilanes.

7. The method of claim 2, wherein said sol-gel matrix comprises a first and second partially hydrolyzed and/or condensed silane, wherein said first silane is a short-chain alkyltrialkoxysilane, and said second silane is a tetraalkoxysilane.

8. The method of claim 2, wherein said sol-gel matrix comprises a first, second and third partially hydrolyzed and/or condensed silane, wherein said first silane is a long-chain alkyltrialkoxysilane, said second silane is a short-chain alkyltrialkoxysilane, and said third silane is a tetraalkoxysilane.

9. The method of claim 2, wherein said sol-gel matrix comprises a first, second, third and fourth partially hydrolyzed and/or condensed silane wherein said first silane is a long-chain alkyltrialkoxysilane, said second silane is a perfluoalkyltrialkoxysilane, said third silane is a short-chain alkyltrialkoxysilane, and said fourth silane that is a tetraalkoxysilane.

10. The method of claim 2, wherein said composition comprising a sol-gel matrix further comprises an organic solvent.

11. The method of claim 2, wherein said sol-gel matrix is prepared by mixing said silanes, and a catalyst for partially hydrolyzing alkoxy groups on the silanes.

12. The method of any one of claim 2, wherein said sol-gel matrix comprises two partially hydrolyzed and/or condensed alkoxysilanes, said alkoxysilanes are 50 mole % of short-chain alkyltrialkoxysilane and 50 mole % of tetraalkoxysilane.

13. The method of claim 2, wherein said sol-gel matrix comprises three partially hydrolyzed and/or condensed alkoxysilanes, said alkoxysilanes are 1 mole % of long-chain alkyltrialkoxysilane, 49 mole % of short-chain alkyltrialkoxysilane and 50 mole % of tetraalkoxysilane.

14. The method of claim 2, wherein said sol-gel matrix comprises two partially hydrolyzed and/or condensed alkoxysilanes, said alkoxysilanes are 20 mole % of perfluoroalkyltrialkoxysilane and 80 mole % of tetraalkoxysilane

15. The method of claim 2, wherein said sol-gel matrix comprises four partially hydrolyzed and/or condensed alkoxysilanes, said alkoxysilanes are 1 mole % of long-chain alkyltrialkoxysilane,14 mole % of perfluoroalkyltrialkoxysilane, 35 mole % of short-chain alkyltrialkoxysilane and 50 mole % of tetraalkoxysilane.

16. The method of claim 5, wherein said long-chain alkyltrialkoxysilane has the following structure:
(RO)₃—Si—R′
where, in this structure, R′ is a long-chain alkyl group of C₁₀ to C₃₀, and R is an alkyl group of C₁, C₂, or C₃.

17. The method of claim 5, wherein said short-chain alkyltrialkoxysilane has the following structure:
(RO)₃—Si—R′
where, in this structure, R′ is a short-chain alkyl group of C₁ to C₈ and R is C₁, C₂, or C₃ alkyl group.

18. The method of claim 5, wherein said perfluoroalkyltrialkoxysilane has the following structure:
(RO)₃—Si—R′
where, in this structure, R′ is a perfluoroalkyl group of C₈ to C₃₀ and R is a C₁, C₂, or C₃ alkyl group.

19. The method of claim 5, wherein said tetraalkoxysilane has the following structure:
(RO)₃—Si—OR
wherein R are each independently, C₁, C₂, or C₃ alkoxy groups.
